(19) United States
(12) Patent Application Publication
(10) Pub. No.: US 2026/0261188 A1
(43) Pub. Date: Sep. 3, 2026

(54) ELECTROMAGNETIC ACTUATOR COMPRISING A COMPACT AND SILENT SYNCHRONOUS MOTOR WITH EMBEDDED PERMANENT MAGNETS

(71) Applicant: SOMFY ACTIVITES SA, CLUSES (FR)

(72) Inventors: Thierry TOLLANCE, CLUSES (FR); Ronan GEORGEAULT, CLUSES (FR); Frédéric GILLON, VILLENEUVE D'ASCQ (FR); Abdelmounaïm TOUNZI, VILLENEUVE D'ASCQ (FR); Michel HECQUET, VILLENEUVE D'ASCQ (FR)

(21) Appl. No.: 18/878,325

(22) PCT Filed: Jun. 16, 2023
(86) PCT No.: PCT/FR2023/050877

§ 371 Date: Dec. 23, 2024

(30) Foreign Application Priority Data
Jun. 24, 2022 (FR) FR2206346

(51) Int. Cl. H02K 21/16; E06B 9/72; H02K 1/276

(52) U.S. Cl. CPC H02K 21/16; E06B 9/72; H02K 1/276; H02K 2213/03

(57) ABSTRACT

The present disclosure relates to an electromechanical actuator including a permanent magnet synchronous type motor and a motor control unit, the motor including: a rotor of cylindrical shape, permanent magnets associated with the rotor and forming magnetic poles, a stator of cylindrical shape, arranged coaxially around the rotor and comprising a plurality of teeth extending radially towards the rotor, and a coil forming a winding around each of the teeth of the stator, and wherein the permanent magnets are based on ferrite, the stator has an outer diameter of less than 55 mm, the rotor comprises recesses forming a flux barrier around a longitudinal axis of the rotor, and the permanent magnets are inserted into the recesses of the rotor.

### CROSS REFERENCE TO RELATED APPLICATIONS

This application is a National Stage of PCT Application No. PCT/FR2023/050877 filed on Jun. 16, 2023, which claims priority to French Patent Application No. 22/06346 filed on Jun. 24, 2022, the contents each of which are incorporated herein by reference thereto.

### TECHNICAL FIELD

The present disclosure relates to the field of electric motors and more particularly to synchronous “brushless” electric motors in the power ranges from a few tens of watts to a few hundreds of watts. Such motors are for example implemented in electromechanical actuators in the field of home automation installations. These actuators are used in particular to rotate a winding shaft or tube to drive a roller shutter or a blind to blackout a window or a door of a building.

### BACKGROUND

A synchronous “brushless” electric motor conventionally comprises a rotor and a stator including several windings. In applications where the motor is fitted to an electromechanical actuator driving in rotation a winding tube, it is desirable, for reasons of space, to house the actuator in the winding tube, which imposes heavy constraints on the actuator in terms of volume and temperature. Indeed, the motor itself is encapsulated in a casing, usually made of metal, of the actuator. The diameter of the motor is therefore limited to a few centimeters. Under these conditions, it is difficult to ventilate the motor. On the other hand, the actuator can also be subjected to high temperatures when it is mounted in the winding tube of a roller shutter or a blind mounted on the facade of a building. The length of the motor is also reduced as much as possible to allow an actuator length to be adapted to the widest range of applications.

In the field of synchronous “brushless” electric motors, the permanent magnet synchronous motor is increasingly popular, due to its performance, in particular in terms of power-weight ratio and noise, compared to other motors such as cage induction motors. The permanent magnet synchronous motor can be supplied with a sinusoidal or trapezoidal signal. It also most often comprises Hall effect sensors for detecting the position of the rotor relative to the stator.

However, by reducing the size of the motors, resonance phenomena appear between the electromagnetic forces occurring within the motor and the mechanical elements of the latter. These resonance phenomena correspond to a noise spectrum that can comprise peaks in the audible frequency range that prove to be annoying to humans.

In this type of permanent magnet synchronous motor, it is known to form grooves on the stator to limit the amplitude of “cogging” (torque variation over one revolution). It is also known to form grooves on the rotor in order to increase the motor torque by increasing the reluctance torque. The addition of uniformly distributed grooves on the rotor and/or on the stator also makes it possible to add resolution steps on stepper motors.

It is therefore desirable to propose improvements to permanent magnet synchronous type motors, in order to reduce their cost, without penalizing their performance in terms of generated torque, power consumption, released heat and generated noise.

### BRIEF SUMMARY

Embodiments relate to an electromechanical actuator for actuating a blackout device such as a roller shutter or a blind, comprising a casing, a head intended to be fastened to a fixed structure, a permanent magnet synchronous type motor, a speed reducer and a motor control unit, the motor, the speed reducer and the control unit being inserted into the casing of the electromechanical actuator, the motor comprising: a rotor of cylindrical shape, permanent magnets associated with the rotor and forming magnetic poles, a stator of cylindrical shape, arranged coaxially about the rotor and including a plurality of teeth extending radially towards the rotor, and a coil forming a winding about each of the teeth of the stator. According to one embodiment, the stator has an external diameter smaller than 55 mm, the rotor comprises recesses formed about a longitudinal axis of the rotor and extending to a cylindrical face of the rotor, and the permanent magnets are inserted into the recesses of the rotor.

The actuator thus defined is particularly compact and inexpensive, while providing performance adapted in particular to roller shutter control applications. In particular, these arrangements make it possible to reduce the volume of the magnets without significantly affecting the performance of the motor. The recesses form flow barriers.

According to one embodiment, the rotor comprises four magnetic poles each comprising one of the permanent magnets.

According to one embodiment, the stator comprises six teeth.

The diameter of the motor can be reduced by choosing a reduced number of magnetic poles and windings, without affecting the performance of the motor in terms of torque, power consumption and heat emission. The 6 windings/4 magnetic poles pair has interesting performance in the field of application of blinds and roller shutters, with a particularly compact stator.

According to one embodiment, the rotor comprises a first rotor groove extending on a cylindrical face of the rotor facing each of the permanent magnets, the first rotor groove being centered on a line located outside a first median plane of the permanent magnet, passing through a longitudinal axis of the rotor.

By modifying the air gap permeance of the motor, this first groove makes it possible to attenuate an annoying peak in the noise spectrum emitted by the motor, without significantly affecting the performance of the motor.

According to one embodiment, the rotor comprises a second rotor groove extending on a cylindrical face of the rotor facing each of the permanent magnets.

This second groove also modifies the air gap permeance of the motor and therefore can also modify the noise spectrum.

According to one embodiment, the first and second rotor grooves are arranged symmetrically with respect to the first plane.

This second groove makes it possible to symmetrize the behavior of the motor in both directions of rotation and thus to obtain an identical result regardless of the direction of rotation of the motor. Thanks to this arrangement, the symmetry of behavior of the motor in terms of noise and performance can be adapted to the operation of the actuator for winding or unwinding a mobile screen, regardless of the mounting direction of the actuator.

According to one embodiment, the first or second rotor groove or each of the first and second rotor grooves has at least one of the following characteristics: an angular position about the longitudinal axis of the rotor with respect to the first plane of between 0 and 35°, a semi-circular section, and a semi-circular section having a radius of between 0.4 and 1.8 mm.

According to one embodiment, each tooth of the stator comprises a stator groove formed in a free end of the tooth.

This arrangement in combination or not with one or two grooves on the rotor also makes it possible to reduce the audible noise peak emitted by the motor, without significantly affecting the performance of the motor.

According to one embodiment, the stator groove formed in each tooth of the stator has at least one of the following characteristics: it is centered on a second median plane of the tooth and passing through a longitudinal plane of the stator, it has a width of 0.2 to 3 mm, and it has a depth of 0.2 to 6 mm.

The centered position of the grooves in the teeth of the stator makes it possible to further reduce the audible noise peak emitted by the motor.

According to one embodiment, the permanent magnets have a parallelepiped shape, and/or are made of ferrite or plastoferrite.

Magnets having this shape are particularly inexpensive. The use of plastoferrite makes it possible to further reduce the cost of the motor without reducing its performance, in particular if the entire volume of the recesses is filled with this material.

According to one embodiment, the control unit applies a sinusoidal or trapezoidal control to the motor.

The performance of the motor can be achieved by either of these control types.

According to one embodiment, the rotor and/or the stator are formed by an assembly of sheet metal plates.

This manufacturing technique proves to be particularly fast and inexpensive. In addition, it makes it possible to easily modify the length of the rotor or the stator according to the desired performance, in particular the torque to be provided by the motor. In addition, this technique makes it possible to simplify the production of the grooves which can be obtained by forming notches in the sheet metal plates.

According to one embodiment, the motor has a power less than or equal to 300 W.

The aforementioned characteristics of the motor are particularly suitable for motors in this power range.

Embodiments may also relate to a blackout device of the roller shutter or blind type, comprising an actuator as previously defined.

### BRIEF DESCRIPTION OF THE FIGURES

The present disclosure will be better understood from the following description with reference to the appended figures, in which identical reference signs correspond to structurally and/or functionally identical or similar elements.

FIG. 1 is a schematic perspective and longitudinal sectional view of a permanent magnet synchronous motor, according to one embodiment,

FIG. 2 is a schematic cross-sectional view of the permanent magnet synchronous motor, according to one embodiment,

FIG. 3 is a schematic side view of a rotor of the permanent magnet synchronous motor, according to one embodiment,

FIG. 4 is a schematic cross-sectional view of the rotor, according to one embodiment,

FIG. 5 is a schematic top view of a plate of the rotor, according to one embodiment,

FIG. 6 is a schematic top view of a plate of the rotor, according to another embodiment,

FIG. 7 is a schematic top view of a plate of the rotor, according to another embodiment,

FIGS. 8, 8A are schematic cross-sectional views of a permanent magnet synchronous motor, according to one embodiment, FIG. 8A being an enlarged view of a part of FIG. 8,

FIG. 9 is a schematic cross-sectional view of an actuator, according to one embodiment,

FIG. 10 is a schematic perspective view of a home automation installation, according to one embodiment.

### DETAILED DESCRIPTION

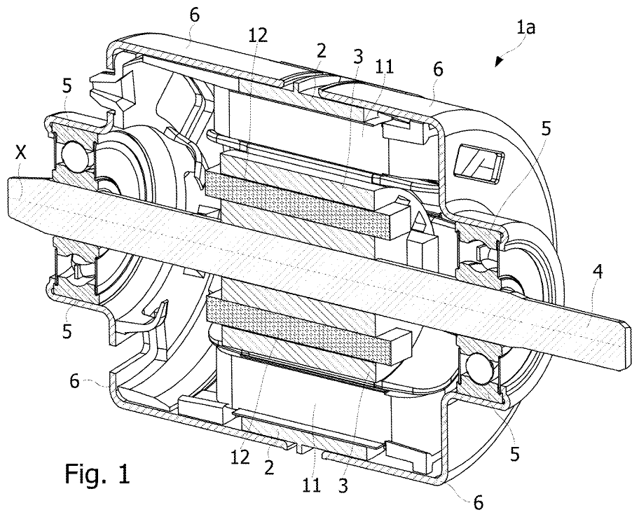

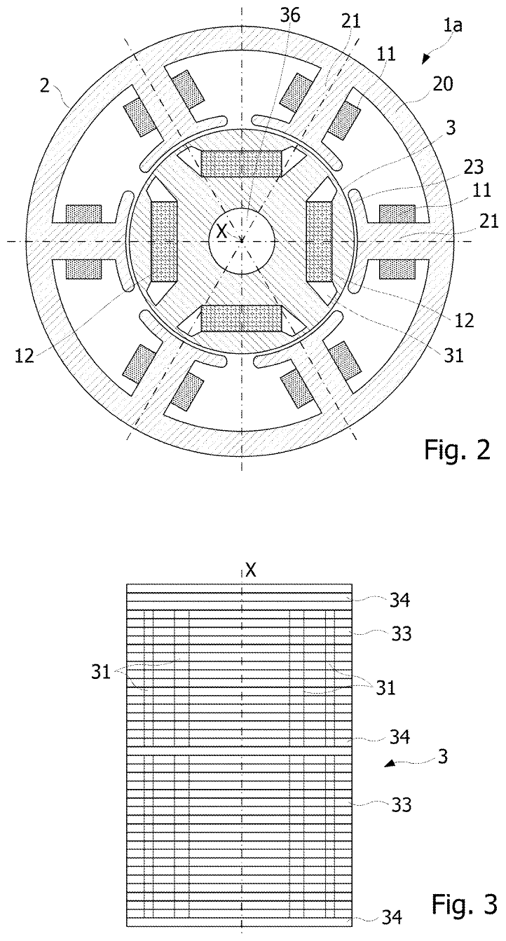

FIGS. 1 and 2 represent a permanent magnet synchronous type motor 1a, according to one embodiment. The motor 1a comprises a stator 2, a rotor 3 and a shaft 4 secured to the rotor, these three elements being coaxial and housed in a casing 6. The casing 6 is secured to the stator 2 and connected to the shaft 4 through bearings 5, for example of the ball bearing type.

In FIG. 2, the stator 2 has a hollow cylindrical shape 20 and comprises teeth 21 extending radially towards the inside of the cylindrical portion 20. The teeth are provided to each receive a winding 11. The teeth 21 may each have a free end extended by a tile-shaped plate 23.

According to one embodiment, the rotor 3 is of the inserted permanent magnet type. Thus, the rotor 3 has a cylindrical outer contour, inside which are formed recesses 31 forming flux barriers, the recesses being distributed about the longitudinal axis X of the rotor. The rotor also has a central bore 36 in which the shaft 4 driven in rotation by the rotation of the rotor 3 is fastened. Permanent magnets 12 are inserted into the recesses. The curved plates 23 at the end of the teeth 21 match the cylindrical shape of the rotor 3 while maintaining a substantially constant air gap in the facing region between each plate 23 and the outer contour of the rotor 3.

In the example of FIG. 2, the stator 2 comprises six teeth 21 and the rotor 3 comprises four magnetic poles formed by the magnets 12. The magnets 12 have a parallelepiped shape. To limit costs, the magnets can be made, not from rare earth, but from ferrite or plastoferrite. The magnets 12 can thus be inserted into the recesses 31 either because the section of the solid magnets corresponds substantially to that of a portion of the recesses, or in the form of plastoferrite paste which then fills the recesses during the manufacture of the motor.

The axial length of the magnets 12 may be greater than that of the stator so as to be able to capture the flux of the magnets by Hall effect sensors which give the position of the rotor necessary for driving the motor 1a.

The stator 2 has an external diameter smaller than 55 mm, for example between 35 and 55 mm. It may have a length of between 14 and 20 mm. The rotor 3 may have a diameter of between 18 and 25 mm and a length of between 18 and 25 mm. The air gap may be between 0.2 and 0.6 mm, for example equal to 0.3 mm.

The coil forming the windings 11 about the teeth 21 may be single or double-layer, of the dental or concentric and distributed type. The winding can be made with copper wire of 0.12 to 0.2 mm to form between 700 and 1000 turns about the teeth 21.

The stator 2 and the rotor 3 can be made by a stack of a plurality of plates cut from a sheet metal with a small thickness, for example between 0.3 and 0.7 mm. The plates can be assembled by staples, in particular so as to ensure their alignment. Thus, FIG. 3 represents the rotor 3 formed by a stack of two types of plates 33, 34, the plates 34 forming magnetic shunts. In the example of FIG. 3, the rotor 3 is formed of 40 plates 33, 34, including three plates 34, then a group of sixteen plates 33 and a group of nineteen plates 33, separated by a plate 34, and finally a plate 34.

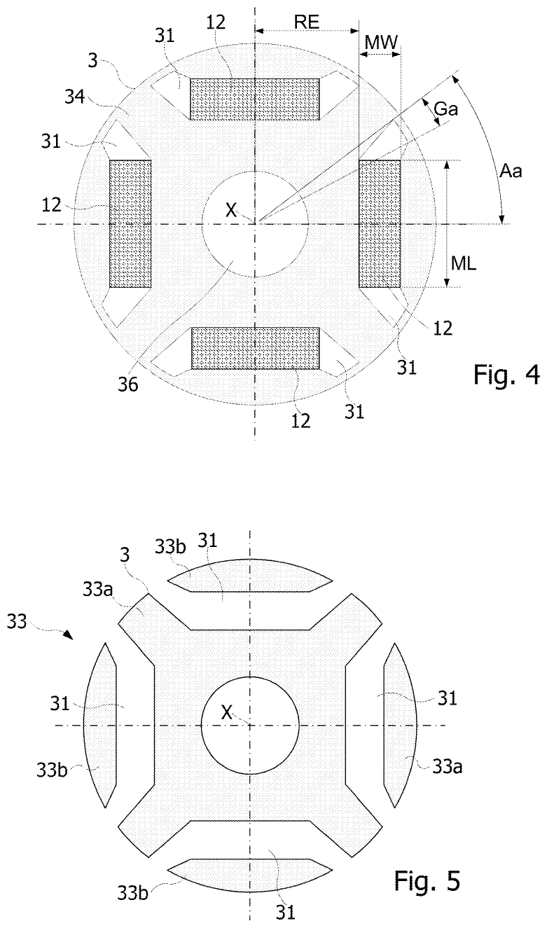

FIGS. 2 and 4 show the shape of the plates 34. According to one embodiment, the magnets 12 have a parallelepiped shape. Thus, the recesses 31 forming the flux barriers and housing the permanent magnets 12 can be defined by the following parameters:
the radius RE of a circle centered on the longitudinal axis X of the rotor 3 beyond which the recesses 31 are formed,
the length ML and the width MW of the magnets 12,
the half angle Aa of extension of the recesses 31 about the longitudinal axis X of the rotor 3, and
the opening angle Ga of the recesses 31 on the edge of the rotor, about the longitudinal axis X of the rotor.

FIG. 5 shows the shape of the plates 33. The plates 33 differ from the plates 34 in that the recesses 31 extend to the edge of the plates, forming the cylindrical face of the rotor, dividing each plate 33 into a central part 33a and peripheral parts 33b delimiting with the plate portion 33a, the contour of the recesses 31.

According to an exemplary embodiment, the stator 2 can have an external diameter of 40.7 mm, an internal diameter of 21.8 mm and a length of 15 mm. The rotor 3 can have a diameter of 21.2 mm and a length of 20 mm. Under these conditions, the parameters RE, ML, MW, Ga, Aa can take the values listed in the following Table 1:

TABLE 1

| RE | ML | MW | Ga | Aa | Magnet volume |
|---|---|---|---|---|---|
| (mm) | (mm) | (mm) | (°) | (°) | (mm³) |
| 5.65 | 7.3 | 2.85 | 12.4 | 84.45 | 414 |

The motor 1a with inexpensive inserted magnets, makes it possible to obtain slightly degraded performances compared to a reference motor of the same type, of the same dimensions, but with plated or bonded permanent magnets. These performances are compared in the following table 2:

TABLE 2

| | Effective inverter | Effective phase | Current density |
|---|---|---|---|
| | current (mA) | current (mA) | (A/mm²) |
| Motor 1a | 320 | 183 | 9.1 |
| Reference motor | 275 | 160 | 8.00 |

These values are obtained with 715-turn windings of 0.15 mm diameter wire, and 0.5 mm thick plates 33, 34, a sinusoidal control being applied to the motor 1a, the average torque obtained on the shaft of the motor 1a being 55 mN·m. As the current density is higher, the motor 1a heats up faster than the reference motor. The values in Table 2 are very little modified if a trapezoidal control is applied to the motors.

However, acoustically, the motor 1a and the reference motor have a noise spectrum comprising a peak at around 2 kHz within the spectrum audible to the human ear. However, the predominance of a noise peak at this frequency proves to be annoying to the human ear, with a perception of a high-pitched noise.

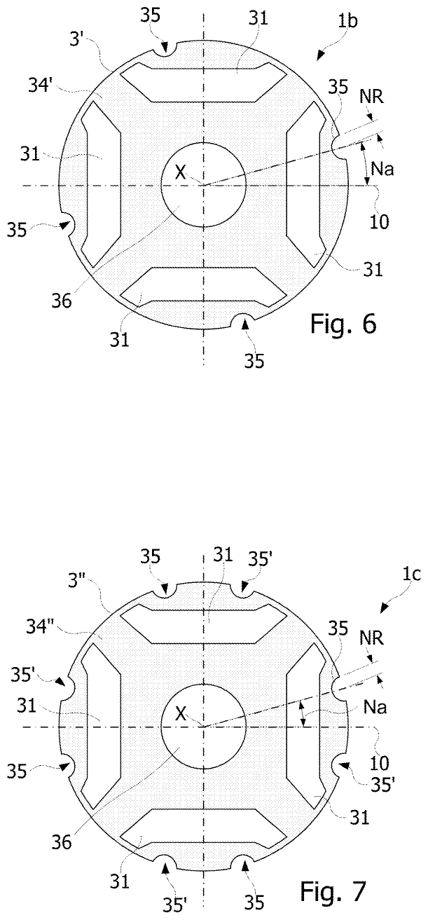

FIG. 6 represents a plate 34′ of a rotor 3′ of a motor 1b, according to one embodiment. The motor 1b differs from the motor 1a only by its rotor 3′. The rotor 3′ of the motor 1b differs from the rotor 3 in that the plates 33′, 34′ have notches distributed on their edge. The notches 35 can be defined for example by their angular position Na and their radius NR. The angular position Na is defined with respect to a median plane 10 of the recesses 31, including the longitudinal axis X of the rotor 3′. Once stacked and assembled, the notches 35 on the edge of the plates 33′, 34′ form grooves extending longitudinally along the rotor 3′.

According to one embodiment, the angular position Na of the notches 35 is between 0 and 35°, and the radius NR of the notches 35 is between 0.4 and 1.8 mm. When the notches 35 have an angular position Na of 20° and a radius NR of 0.7 mm, it can be observed that the audible noise peak is attenuated by 24 dBA, whether the motor 1b is at no load or under load, compared to the motor 1a without notches.

FIG. 7 illustrates a motor 1c according to another embodiment. The motor 1c differs from the motor 1b only by its rotor 3″. The rotor 3″ represented in FIG. 7 differs from the rotor 3′ in that the plates 33′, 34′ are replaced by plates 33″, 34″. The plates 33″, 34″ differ from the plates 33′, 34′ in that they each comprise a second notch 35′ arranged symmetrically to the notch 35 with respect to the median plane 10 of each of the recesses 31. This arrangement does not significantly change the amplitude of the audible noise peak, but has the advantage of symmetrizing the behavior of the motor 1b according to both directions of rotation of the latter, in particular in terms of noise.

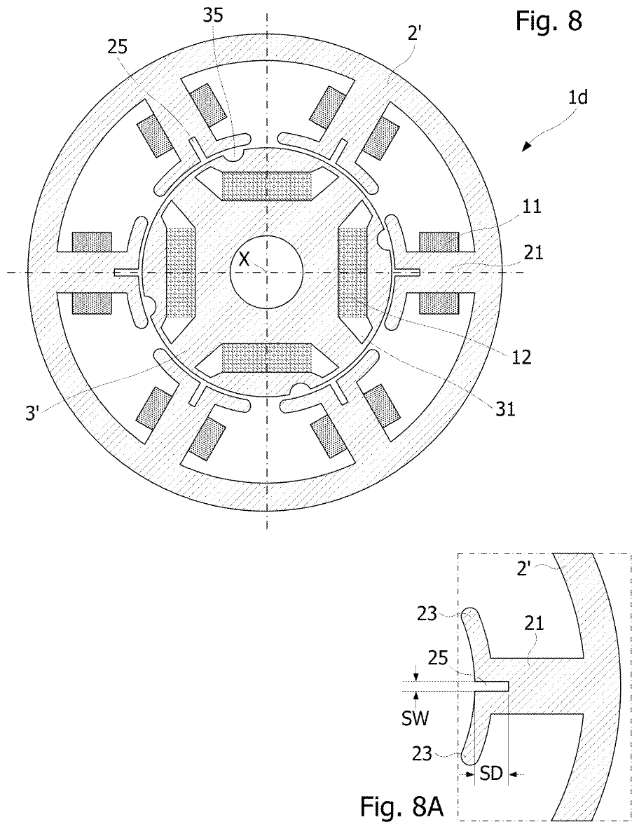

FIGS. 8, 8A illustrate a motor 1d according to another embodiment. The motor 1d is fitted with the rotor 3′ with the plates 33′, 34′ with one notch 35 per pole and a stator 2′. The stator 2′ differs from the stator 2 in that it comprises one notch 25 per tooth 21 in each plate forming the stator. Each tooth 21 of each plate forming the stator 2′ comprises one of the notches 25. Each notch 25 extends from the free end of one of the teeth 21 and is centered on the latter. Thus, the notches 25 form grooves extending longitudinally in the teeth 21 of the stator 2′. In FIG. 8A, each of the notches 25 is defined by its width SW and its depth SD in one of the teeth 21.

According to one embodiment, the notches 25 have a width SW of 0.2 to 3 mm and a depth SD of 0.2 to 6 mm.

By combining the notches 35 with an angular position Na of 25° and a radius NR of 1.25 mm, and the notches 25 with a width SW of 0.5 mm and a depth SD of 1 mm, the audible noise peak is attenuated by 15 dBA, whether the motor is at no load or under load, compared to the motor 1 without notches.

The performances of the motors 1a, 1c and 1d are compared in the following table 3:

TABLE 3

| | Effective inverter | Effective phase | Current density |
|---|---|---|---|
| Motor | current (mA) | current (mA) | (A/mm²) |
| 1a | 320 | 183 | 9.1 |
| 1c | 333 | 192 | 9.5 |
| 1d | 350 | 200 | 9.94 |

These values are obtained with 715-turn windings, and 0.5 mm thick plates 33, 34 and 33″, 34″, a sinusoidal or trapezoidal control being applied to the motor, the average torque obtained on the shaft of the motor being 55 mN·m.

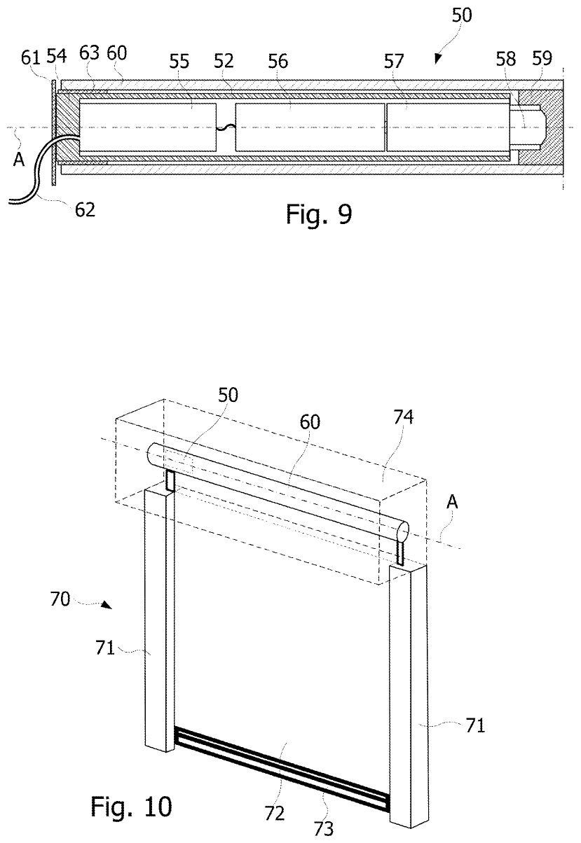

FIG. 9 represents an electromechanical actuator 50 according to one embodiment. The actuator 50 comprises a motor 56 which may be one of the previously described motors 1a, 1b, 41c, 1d, a speed reducer 57 coupled to an output shaft of the motor, and a control unit 55 connected to the motor 56, in particular to supply and drive electrical energy to the latter according to control commands. The speed reducer 57 comprises an output shaft 58 forming an output shaft of the actuator 50. The motor 56, the speed reducer 57, the output shaft 58 and the control unit 55 can be housed coaxially about an axis A in a casing 52 of cylindrical shape having an internal diameter corresponding to the external diameter of the stator of the motor 56. The speed reducer 57 can comprise an epicyclic type reducer and/or a mechanical or electromagnetic brake.

Thus, the actuator 50 can be arranged for example in a winding tube 60 of a blackout device such as a roller shutter or a blind. For this purpose, the output shaft 58 of the actuator 50 is coupled by a mechanical connection 59 to the winding tube 60. Furthermore, a head 54 of the actuator 50 is fastened to a fixed structure 61. The actuator 50 also comprises a bearing crown 63 mounted on the casing 52 and free to rotate relative to the latter. The bearing crown 63 is rotatably fastened to the winding tube 60, so that the bearing crown 63 provides a rotating bearing function for the winding tube 60 on the casing 52 and/or on the head 54, on the control unit 55 side, the output shaft 58 providing on the other side the mechanical coupling between the actuator and the winding tube 60 via the mechanical connection 59.

The electromechanical actuator 50 is supplied with electrical energy by a building's power supply network, for example by the AC mains network or by a direct current bus, or even by means of a battery, not shown, which can be recharged, for example, by a photovoltaic panel. Here, the electromechanical actuator 11 comprises a power supply cable 62 linked to a mains power supply network.

FIG. 10 represents a home automation installation according to one embodiment. The home automation installation can be installed in a building including an opening, window or door, fitted with a screen 72 belonging to a blackout device 70, in particular a motorized roller blind. The blackout device 70 can be alternatively a roller shutter, a blind with adjustable slats, or even a roller door. In practice, the present disclosure applies to all types of blackout device comprising a rotating motorized winding shaft.

The screen 72 of the blackout device 70 is wound on a winding tube such as the winding tube 60 driven by the electromechanical actuator 50. The screen 72 is movable between a wound position, in particular a high position, and an unwound position, in particular a low position.

In a known manner, the screen 72 of the blackout device 70 is formed by a canvas, which is attached by a first end to the winding tube and by the other end to a weighted bar 73. The high wound position of the screen corresponds to the position of the weighted bar at the winding tube 60 and the low unwound position corresponds to the position of the weighted bar 73 of the screen 72 at the sill of the opening. The deployment of the screen 72 can be guided by slides 71. The winding tube 60 can be arranged inside a cassette 74 or be visible. The winding tube 60 is movable in rotation relative to a support, such as a cheek, of the cassette 74.

It will be clear to those skilled in the art that the present disclosure is susceptible to various variants and various applications. In particular, the present disclosure is not limited to actuators for shutters and blinds. It applies more generally to actuators of cylindrical shape having a power less than or equal to 300 W.

Furthermore, the number of magnetic poles of the rotor and the number of teeth of the stator can take other values, without departing from the scope of the present description. If the motor is controlled by three phases, it is simply important that the number of teeth of the stator is a multiple of 3.

The permanent magnets do not necessarily have a parallelepiped shape, but could take any other shape adapted to the shape of the recesses 31. Thus, the magnets can fill the entire volume of the recesses, up to the outer surface of the rotor. The magnets and the empty volumes delimited by the recesses can be tile-shaped.

The angles Na of the notches 35, 35′ are not necessarily identical from one plate 33′, 33″, 34′, 34″ to the other, so that the grooves formed by the notches 35, 35′ are not necessarily parallel to the longitudinal axis X of the rotor, nor even rectilinear. In addition, not all plates 33′, 33″, 34′, 34″ are necessarily provided with notches 35 and/or 35′, so that the grooves on the rotor may be discontinuous or not extend along the entire length of the rotor. Thus, for example, only the plates 33′, 33″ could be provided with notches 35, 35′.

The grooves formed by the notches are not necessarily symmetrical with respect to median planes of the permanent magnets, passing through the longitudinal axis X of the rotor. Indeed, it may not be necessary to symmetrize the behavior of the motor in both directions of rotation, in particular in applications where the motor is only used in one direction of rotation.

The grooves 25 formed in the stator 2′ are not necessarily centered on the teeth 21. Indeed, an off-center position of the grooves 25 makes it possible to reduce the audible noise peak of the motor. In addition, the motor may comprise these stator grooves without grooves on the rotor. Indeed, such an arrangement also makes it possible to reduce the audible noise peak.

The rotor and/or the stator are not necessarily made by an assembly of metal sheet plates. Indeed, each of these elements of the motor can be formed into one (FIG. 4) or several parts (FIG. 5), for example made of metal, obtained by machining or additive manufacturing (3D printing).

1. An electromechanical actuator for actuating a blackout device such as a roller shutter or a blind, comprising a casing, a head intended to be fastened to a fixed structure, a motor of a permanent magnet synchronous type, a speed reducer and a control unit of the motor, the motor, the speed reducer and the control unit being inserted into the casing of the electromechanical actuator, the motor comprising:
a rotor of cylindrical shape,
permanent magnets associated with the rotor and forming magnetic poles,
a stator of cylindrical shape, arranged coaxially about the rotor and including a plurality of teeth extending radially towards the rotor, and
a coil forming a winding about each of the plurality of teeth of the stator,
characterized in that:
the stator has an external diameter smaller than 55 mm,
the rotor comprises recesses formed about a longitudinal axis of the rotor and extending to a cylindrical face of the rotor, and
the permanent magnets are inserted into the recesses of the rotor.

2. The actuator according to claim 1, wherein the rotor comprises four magnetic poles each comprising one of the permanent magnets.

3. The actuator according to claim 1, wherein the comprises six teeth.

4. The actuator according to claim 1, wherein the rotor comprises a first rotor groove extending on a cylindrical face of the rotor facing each of the permanent magnets, the first rotor groove being centered on a line located outside a first median plane of the permanent magnet, passing through the longitudinal axis of the rotor.

5. The actuator according to claim 4, wherein the rotor comprises a second rotor groove extending on a cylindrical face of the rotor facing each of the permanent magnets.

6. The actuator according to claim 5, wherein the first and second rotor grooves are arranged symmetrically with respect to the first plane.

7. The actuator according to claim 5, wherein the first or second rotor groove or each of the first and second rotor grooves has at least one of the following characteristics:
an angular position about the longitudinal axis of the rotor with respect to the first plane of between 0 and 35°,
a semi-circular section, and
a semi-circular section having a radius of between 0.4 and 1.8 mm.

8. The actuator according to claim 1, wherein each tooth of the stator comprises a stator groove formed in a free end of the tooth.

9. The actuator according to claim 8, wherein the stator groove formed in each tooth of the stator has at least one of the following characteristics:
it is centered on a second median plane of the tooth and passing through a longitudinal axis of the stator,
it has a width of 0.2 to 3 mm, and
it has a depth of 0.2 to 6 mm.

10. The actuator according to claim 1, wherein the permanent magnets have a parallelepiped shape, and/or are made of ferrite or plastoferrite.

11. The actuator according to claim 10, wherein the control unit applies a sinusoidal or trapezoidal control to the motor.

12. The actuator according to claim 1, wherein the rotor and/or the stator are formed by an assembly of sheet metal plates.

13. The actuator according to claim 1, wherein the motor has a power less than or equal to 300 W.

14. A blackout device of the roller shutter or blind type, comprising an actuator according to claim 1.

15. The actuator according to claim 2, wherein the stator comprises six teeth.

16. The actuator according to claim 15, wherein the rotor comprises a first rotor groove extending on a cylindrical face of the rotor facing each of the permanent magnets, the first rotor groove being centered on a line located outside a first median plane of the permanent magnet, passing through the longitudinal axis of the rotor.

17. The actuator according to claim 16, wherein the rotor comprises a second rotor groove extending on a cylindrical face of the rotor facing each of the permanent magnets.

18. The actuator according to claim 17, wherein the first and second rotor grooves are arranged symmetrically with respect to the first plane.

19. The actuator according claim 18, wherein the first or second rotor groove or each of the first and second rotor grooves has at least one of the following characteristics:
an angular position about the longitudinal axis of the rotor with respect to the first plane of between 0 and 35°,
a semi-circular section, and
a semi-circular section having a radius of between 0.4 and 1.8 mm.

20. The actuator according to claim 19, wherein each tooth of the stator comprises a stator groove formed in a free end of the tooth.
